(19) United States
(12) Patent Application Publication
(10) Pub. No.: US 2023/0287538 A1
(43) Pub. Date: Sep. 14, 2023

(54) REACTIVE PHASE SEPARATION OF BLACK MASS FROM LITHIUM-ION BATTERY RECYCLING AND METHODS

(71) Applicant: Comstock IP Holdings LLC, Milton, GA (US)

(72) Inventor: Michael J. RIEBEL, Mankato, MN (US)

(21) Appl. No.: 18/166,240

(22) Filed: Feb. 8, 2023

Related U.S. Application Data
(60) Provisional application No. 63/320,069, filed on Mar. 15, 2022.
(60) Provisional application No. 63/307,912, filed on Feb. 8, 2022.

(51) Int. Cl. C22B 26/12; C22B 7/00; H01M 10/54; C01B 32/215

(52) U.S. Cl. CPC C22B 26/12; C22B 7/005; H01M 10/54; C01B 32/215

(57) ABSTRACT

Methods for processing black mass material from lithium-ion battery recycling processes include fractionating the black mass into a lithium fraction, a graphite fraction, and a concentrated metal powder fraction. This is accomplished using a multiphase liquid blend of nonpolar hydrophobic solvent and water to dissolve the lithium and produce a multiphase admixture which, upon gravity separation, produces a graphite layer in the hydrophobic solvent and a mixed metal powder layer that sinks to the bottom of the aqueous layer.

### REFERENCE TO RELATED APPLICATIONS

This application claims priority to U.S. Provisional Application 63/307,912 filed Feb. 8, 2022, and to U.S. Provisional Application 63/320,069 filed Mar. 15, 2022, the entire contents of each being hereby expressly incorporated herein by reference.

### FIELD AND BACKGROUND OF THE INVENTION

The following disclosure generally relates to methods for processing black mass material from lithium-ion battery recycling processes. More specifically, methods to fractionate the black mass into a lithium fraction, a graphite fraction, and a concentrated metal powder fraction are disclosed.

For decades, portable electrical power supplies have taken the form of batteries that release electrical energy from an electrochemical reaction. Various battery chemistries, such as traditional “dry cell” carbon flashlight batteries, and lead acid “wet” cells common in automobiles, have provided adequate portable electrical power.

Advances in lithium-ion batteries (LIBs) have been significant, making them a very popular power source for portable electronics equipment. LIBs are also growing in popularity for military, electric vehicle, and aerospace applications. Continuing development of personnel electronics and hybrid and electric vehicles likely ensures that Li-ion batteries will continue to be increasingly in demand.

With the growing demand and advances in lithium-ion batteries, there is now concern over the “end of life” issues and the inability to safely and efficiently recycle the valuable materials within the batteries. Because lithium-ion batteries contain valued materials, some of which are a very limited resource, recycling is highly desired, particularly as the demand for high performance electrical batteries continues to grow. For example, lithium-ion batteries contain valued elements such as cobalt (Co), nickel (Ni), manganese (Mn) and lithium (Li). However, they also include packaging materials such as plastics and metals for their protective casing.

In most lithium-ion battery recycling operations, electrolyte or solvent is removed, copper and aluminum foils are removed along with plastics and various packaging materials, and a fine, granular black mass material remains. This “black mass” comprises lithium carbonate, graphite, and a blend of fine granular metals including cobalt, nickel, and other valued metals. A simple, low-cost method for lithium dissolution, graphite separation, and residual valuable metal separation would be of great value.

### SUMMARY OF THE INVENTION

Methods for processing black mass from lithium-ion battery recycling processes include mixing the black mass with a multiphase liquid blend of nonpolar hydrophobic solvent, water, and an acid to produce a multiphase admixture. The black mass contains lithium, graphite, and mixed metals. At least a portion of the lithium is dissolved in the water. The resulting multiphase admixture is gravity phase separated to produce a graphite layer, a mixed metal layer, a hydrophobic solvent layer, and an aqueous layer. The aqueous layer is treated to recover the lithium.

In one embodiment the nonpolar hydrophobic solvent comprises hexane and the acid comprises acetic acid.

In one embodiment, the aqueous layer is evaporated to recover the lithium.

### BRIEF DESCRIPTION OF THE DRAWINGS

The accompanying drawings, which are incorporated in and constitute a part of this specification, illustrate one or more implementations described herein and, together with the description, explain these implementations. The drawings are not intended to be drawn to scale, and certain features and certain views of the figures may be shown exaggerated, to scale or in schematic in the interest of clarity and conciseness. Not every component may be labeled in every drawing. Like reference numerals in the figures may represent and refer to the same or similar element or function. In the drawings:

FIG. 1 is a flowsheet illustrating black mass separation in accordance with one embodiment of the present disclosure.

FIG. 2 is a flowsheet illustrating black mass separation in accordance with another embodiment of the present disclosure.

FIG. 3 is a flowsheet illustrating black mass separation in accordance with yet another embodiment of the present disclosure.

### DETAILED DESCRIPTION

Before explaining at least one embodiment of the presently disclosed methods and processes in detail, it is to be understood that the present disclosure is not limited in its application to the details of construction and the arrangement of the components or steps or methodologies set forth in the following description or illustrated in the drawings. The presently disclosed methods and processes are capable of other embodiments or of being practiced or carried out in various ways. Also, it is to be understood that the phraseology and terminology employed herein is for the purpose of description and should not be regarded as limiting.

Unless otherwise defined herein, technical terms used in connection with the present disclosure shall have the meanings that are commonly understood by those of ordinary skill in the art. Further, unless otherwise required by context, singular terms shall include pluralities and plural terms shall include the singular.

All of the articles and/or methods disclosed herein can be made and executed without undue experimentation in light of the present disclosure. While the articles and methods disclosed have been described in terms of preferred embodiments, it will be apparent to those skilled in the art that variations may be applied to the articles and/or methods and in the steps or in the sequence of steps of the method described herein without departing from the concept, spirit, and scope of the present disclosure. All such similar substitutes and modifications apparent to those skilled in the art are deemed to be within the spirit, scope, and concept of the presently disclosure.

As utilized in accordance with the present disclosure, the following terms, unless otherwise indicated, shall be understood to have the following meanings:

The use of the word “a” or “an” when used in conjunction with the term “comprising” in the claims and/or the specification may mean “one”, but it is also consistent with the meaning of “one or more,” “at least one,” and “one or more than one.” The use of the term “or” in the claims is used to mean “and/or” unless explicitly indicated to refer to alternatives only or that the alternatives are mutually exclusive, although the disclosure supports a definition that refers to only alternatives and “and/or.”

Throughout this application, the term “about” is used to indicate that a value includes the inherent variation of error for the device, the method being employed to determine the value, or the variation that exists among the study subjects. For example, but not by way of limitation, when the term “about” is utilized, the designated value may vary by plus or minus twelve percent, or eleven percent, or ten percent, or nine percent, or eight percent, or seven percent, or six percent, or five percent, or four percent, or three percent, or two percent, or one percent. The use of the term “at least one of X, Y, and Z” will be understood to include X alone, Y alone, and Z alone, as well as any combination of X, Y, and Z. The use of ordinal number terminology (i.e., “first,” “second,” “third,” “fourth,” etc.) is solely for the purpose of differentiating between two or more items and is not meant to imply any sequence or order or importance to one item over another or any order of addition, for example.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AAB, BBC, AAABCCCC, CBBAAA, CABABB, and so forth. The skilled artisan will understand that typically there is no limit on the number of items or terms in any combination unless otherwise apparent from the context.

As used herein, the term “substantially” means that the subsequently described event or circumstance completely occurs or that the subsequently described event or circumstance occurs to a great extent or degree. For example, when associated with a particular event or circumstance, the term “substantially” means that the subsequently described event or circumstance occurs at least 80% of the time, or at least 85% of the time, or at least 90% of the time, or at least 95% of the time. The term “substantially adjacent” may mean that two items are 100% adjacent to one another, or that the two items are within close proximity to one another but not 100% adjacent to one another, or that a portion of one of the two items is not 100% adjacent to the other item but is within close proximity to the other item.

The term “associate” as used herein will be understood to refer to the direct or indirect connection of two or more items.

The presently disclosed methods and processes start with black mass derived from LIB battery recycling processes wherein the LIB batteries are generally crushed, ground and separated into aluminum, copper, plastics, packaging materials, and black mass. In one embodiment presently disclosed, black mass is fractionated into a lithium fraction, a graphite fraction, and a concentrated metal powder fraction.

Black mass derived from lithium-ion battery recycling can comprise four different species of lithium: (1) Lithium hydroxide which dissolves in water (water soluble); (2) Lithium carbonate which is nonpolar (does not dissolve significantly in water); (3) Lithium fluoride which is nonpolar (does not dissolve significantly in water); and (4) Lithium oxides which dissolve in water to make hydroxides. Thus, this combination of polar and nonpolar species of lithium together creates a challenge to extract high yields of lithium for recovery. Moreover, the original lithium-ion battery uses an electrolyte comprising lithium hexafluorophosphates.

Most of the electrolytes used in commercial lithium-ion batteries are non-aqueous solutions, in which lithium hexafluorophosphate (LiPF₆) salt is dissolved in organic carbonates, in particular, mixtures of ethylene carbonate (EC) with dimethyl carbonate (DMC), propylene carbonate (PC), diethyl carbonate (DEC), and/or ethyl methyl carbonate (EMC).

A major challenge relates to the lithium hexafluorophosphate during pyrolysis of the ground lithium-ion battery, which is typically done at temperatures around 500° C. to remove the solvent portion of the electrolyte. First, at this temperature, the lithium hexafluorophosphate melts, having a melting point of approximately 200° C. Secondly, a portion of the lithium hexafluorophosphate can be converted into lithium fluoride which we believe is why we see lithium fluoride as part of the lithium species in the black mass. Lithium fluoride has a melting point of 840° C. and can thus “fuse” the graphite and metal together and block the LiF and other lithium species within the black mass from efficient extraction.

A key hurdle is the dissolution of the LiF material so as to break the fused materials and provide access for extraction of the various lithium species. One approach is the use of supercritical CO₂ to extract the lithium species; however, this takes significant time, typically between 3-4 hours at supercritical state to dissolve the lithium species efficiently for extraction.

Within the present disclosure, we utilize a multiphase liquid. For example, in one embodiment, the multiphase liquid comprises a blend of solvent and water. Solvents, particularly hexane, can additionally dissolve or soften fluoropolymer binder which helps separate the fine metal particles from the graphite. Hexane in particular also helps to dissolve lithium hexafluorophosphate.

The multiphase liquid can optionally further comprise an acid such as acetic acid or other forms of acids. While not required, the acid can also help to break the fusion between the fine metal particulates and the graphite as well as assist in the conversion of various lithium species to improve their ability to be dissolved. This allows for more efficient and easier extraction/separation and more efficient recovery of lithium

In general, the multiphase liquid is provided by blending a nonpolar hydrophobic solvent with water. The volume ratio of nonpolar hydrophobic solvent to water is in a range of from about 30:70 to 70:30 or from about 40:60 to about 60:40. In one embodiment the nonpolar hydrophobic solvent is blended with water at a ratio of approximately 50/50. Suitable examples of the nonpolar hydrophobic liquid include, but are not limited to, butanol, pentanol, hexanol, hexane, heptane, toluene, carbon tetrachloride, chloroform, methylene chloride, ethyl ether, vegetable oils, various esters, terpenes and blends thereof. Other hydrophobic solvents such as gasoline, diesel fuel, naphthalene, turpentine, light oils, methanol, ethanol and combinations thereof can also be included. It is a key part of this disclosure that a hydrophobic solvent is used and blended with water to form a multiphase liquid.

In one embodiment a primary hydrophobic nonpolar solvent in the multiphase liquid has a lower boiling or vaporization point than the water. In another embodiment, hexane and water are used to provide the multiphase liquid.

In one embodiment, the multiphase liquid further comprises an acid in sufficient quantities to dissolve the lithium carbonate in the black mass. Acids that are compatible with both the nonpolar hydrophobic solvent and water are within the embodiment. Any acid that is compatible with hexane can be used.

In another embodiment, the multiphase liquid comprises acetic acid at sufficient percentages to fully dissolve the lithium carbonate in the black mass. While most if not all of the lithium dissolves in the aqueous phase, some lithium can also be present in the solvent.

In yet another embodiment, lithium in the black mass is in a water soluble form and is dissolved into the aqueous phase without the use of an acid.

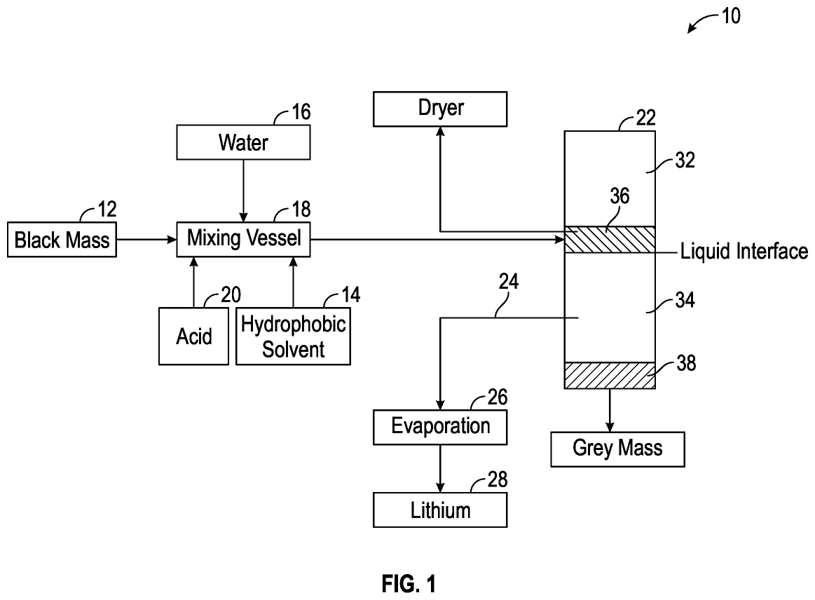

Referring now to FIG. 1, in one embodiment, a process 10 for treating black mass 12 from lithium-ion battery recycling comprises mixing the black mass 12 with a hydrophobic solvent 14 and water 16 in a mixing vessel 18. Optionally, an acid 20 is added to the mixing vessel 18. The admixture of the resulting multiphase solution and black mass is stirred for a period of time sufficient for the lithium in the black mass to be dissolved. The mixture then undergoes a phase separation step 22.

Various orders of additions can be utilized. For example, hydrophobic nonpolar solvent, water, and acid (for example acetic acid) can all be blended together to form a multiphase solution, and then the black mass added and stirred for a period of time sufficient for the lithium to be dissolved.

In another embodiment, black mass is added first to a mixture of hydrophobic nonpolar solvent and acid, for example a hexane/acetic acid mixture, and then the admixture of the multiphase solution and black mass are stirred for a period of time sufficient to fully dissolve the lithium carbonate from the black mass. Then water is added prior to phase separation 22.

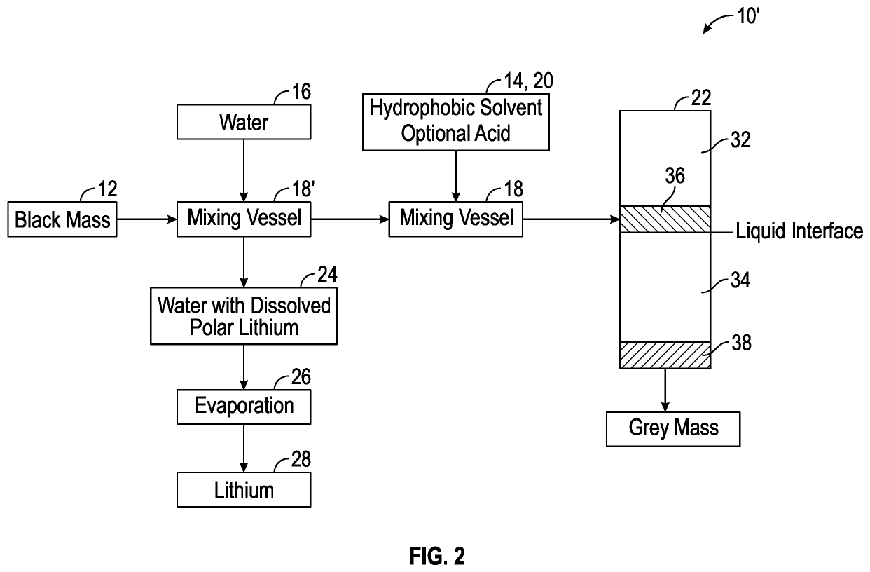

In yet other embodiments, and as shown in FIG. 2, water 16 can be mixed in mixing vessel 18′ with the black mass 12 to dissolve polar lithium in the black mass 12. After separation (not shown) water with dissolved lithium 24 can undergo evaporation 26 to recover a first lithium product 28. Water and water-leached black mass 30 can then be combined with hydrophobic nonpolar solvent 14 and optionally an acid 20 in mixing vessel 18 to dissolve remaining lithium from the water-leached black mass 30. The resulting mixture then undergoes a phase separation step 22.

Examples of suitable mixing equipment include, but are not limited to, standard agitator mixers, static mixers, high shear mixers, and other mixing technologies known to those skilled in the art. In one embodiment, ultrasonic mixing is utilized. Ultrasonic mixing can aid in the clean separation of black mass particles.

In the separation step 22, the admixture is allowed to separate, such as by gravity separation, for a period of time sufficient for full gravity separation. The nonpolar hydrophobic solvent, for example hexane, and dissolved nonpolar lithium, are represented in the top hydrophobic layer 32. The water and dissolved polar lithium is represented in the bottom aqueous layer 34. The remaining solids are basically graphite and, being nonpolar, stays within the top hydrophobic layer 32 but settles to the bottom of this hydrophobic layer forming a graphite layer 36. We find that the metals, being polar, fall to the bottom of the lower aqueous layer 34 upon settling, forming a mixed metal powder 38 sometimes referred to as “grey mass.” The lithium is dissolved and can be in the hydrophobic layer 32 and can have some percentages in the aqueous layer 34 based on the type of solvent. Given acetic acid is miscible in both hexane and water, in this configuration the acetic acid may contain the dissolved lithium carbonate in either phase or both phases. If different acids are used that are only hydrophobic, then the dissolved lithium will stay within the hydrophobic layer 32.

The layers of the separated multiphase mixture are further separated by processes including filtration, extraction, or other standard means known to those skilled in the art to remove both the fine metal granular layer 38 on the bottom and the graphite layer 34 in the middle of the separated multiphase mixture. Once the solids have been removed, the dissolved lithium can be recovered by known means, for example, by simply evaporating the liquids in which the dissolved lithium is contained.

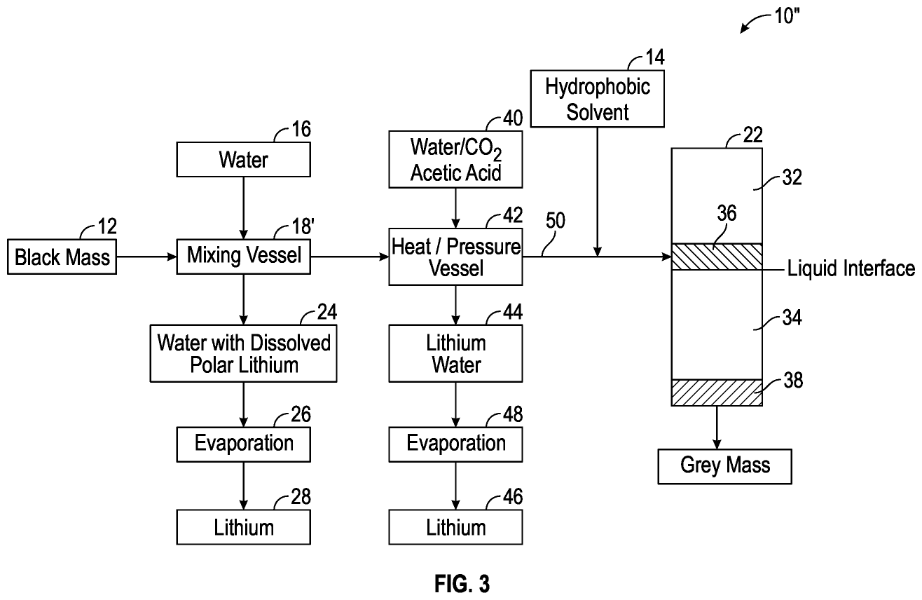

In an embodiment shown in FIG. 3, water-leached black mass 30 can be combined with a mixture 40 of water, acid (for example acetic acid) and CO₂ in a heated pressure vessel 42 to convert lithium remaining in the water-leached black mass 30 to lithium carbonate. The lithium carbonate is dissolved in the water/CO₂/acid mixture 40 and lithium carbonate 48 can be recovered in an evaporation step 48. The solids 50 exiting the heated pressure vessel are gravity separated to provide a graphite product and a mixed metal powder or grey mass product. Gravity separation can be accomplished by addition of hydrophobic solvent 14 and additional water if necessary to the solids 50 followed by a phase separation step 22 as described above.

Hence the above disclosure provides a method and process wherein black mass can be treated in one step to separate the graphite from the mixed metal fine granular material and dissolve the lithium for recovery. A multiphase liquid comprising a nonpolar hydrophobic liquid, water and an acid is used to dissolve and recover lithium from the black mass. A clean graphite material is produced that can be recycled for Li-ion battery production or in other graphite/carbon applications, and a fine granular metal blend is produced that can be further separated and used in the building of new lithium-ion batteries.

In order to more fully describe the presently disclosed methods and concepts, the following examples are set forth. However, it is to be understood that the examples are for illustrative purposes only and are not to be construed as limiting the present disclosure.

### EXAMPLES

### Experiment 1—Evaluation of Nonpolar Hydrophobic Liquids

We selected a few non polar hydrophobic solvents including butanol and hexane and blended them with water that had food coloring within as to see the interface between the layers. The butanol/colored water took some time to phase separation and had a “cloudy” interface. The hexane with colored water had a very sharp interface.

### Experiment 2—Testing of the Acetic Acid and Lithium Carbonate

We took a blend of water and acetic acid (acetic acid concentration of 3%) and blended it with the black mass. We did not notice any separation of creation of layers. We then took a second batch of the water acetic acid and blended in lithium carbonate. To our surprise, the lithium carbonate foamed and quickly dissolved in the solution forming a reaction. We tested the pH of the ending solution given we knew that the acetic acid had a pH around 4 and found that the liquid was now a neutral pH and lithium carbonate was fully dissolved into solution.

### Experiment 3—Reactive Phase Separation Tests

A blend of 50% water and 50% hexane was prepared. Acetic acid was added at a concentration of approximately 2%. The total liquid volume was about 200 mL. We added one teaspoon of black mass we obtained from Comstock Mining to the multiphase admixture and stirred for about 5 minutes. The hexane layer was quickly formed and the aqueous layer was still slightly cloudy black. After sitting for one hour we noticed that the aqueous layer cleared and the metal fine particles were at the bottom of the beaker.

### Experiment 4—Order of Addition

We again took water and a 3% addition of acetic acid and added a small percentage of black mass while mixing. After mixing for 5 minutes, the liquid stayed black and did not phase separate nor show any signs of material (graphite) floating on the top surface. We then poured in an equally amount of hexane while vigorously mixing. We then left the material sit and it gravity separated right away and was fully separated and layers settled out within one hour.

### Experiment 5 Lithium and Samples

We took the graphite material and fine metal granular material, keeping them separate, and dried them. We then took both liquid fractions and separated them. We evaporated each of the liquid fractions to recover the lithium. We then subjected all three samples for analytical testing.

### Experiment 6—Water Test/Water, Hexane Test for Fusion

Water only—Black mass was obtained from Comstock Mining derived from lithium cobalt nickel batteries. The material was simply mixed in water for 5 minutes. The black mass simply sat the bottom of the beaker after mixing stopped. We expected that the graphite would float, but it did not.

Hexane only—The same black mass was placed in hexane only and mixed for 5 minutes. As we expected the black mass simply fell to the bottom of the liquid and we saw no separation.

Hexane/water—We blended a 50/50 blend of hexane and water and poured in the same amount of black mass while mixing vigorously. To our surprise, after stopping the mixing, the graphite was at the top and was a surprising volume in the hexane top layer but between the hexane and water phase separation layer. The metal dropped to the very bottom of the lower aqueous layer. From this experiment we assumed that the black mass particles may be “fused” together given we could not float out the graphite and that the solvent part of the multiphase solution may be sufficient to release the materials by dissolving the chemical or chemicals that fused the material together from pyrolysis (pyrolysis is used to remove the solvents in the electrolyte portion of the battery material).

Hexane/water/acetic—We blended hexane with a water comprising 3% acetic acid and repeated the addition of black mass while mixing. The results were similar to that of the above test wherein we saw a separation and significant volume increase of the graphite and metal falling to the bottom.

### Experiment 7—Lithium Extraction of Both Liquid Layers

Hexane liquid—We took the hexane liquid layer after filtering out the graphite and evaporated it leaving a white powder of lithium.

Aqueous liquid—We took the aqueous bottom layer after filtering out the metals and evaporated also leaving white lithium powder.

### Experiment 8—CO₂ Bubbling

We repeated the test blending hexane and water with black mass, then bubbled CO₂ into the liquid to convert any additional lithium hydroxide into lithium carbonate seeing higher percentages of lithium move to one of the phase separated liquid layers.

### Experiment 9—Secondary Supercritical CO₂

We took the solids after phase separating the black mass with hexane and water by filtration, then placed the solids into a supercritical CO₂ extraction unit. We found that we could extract addition lithium from this secondary method.

Although the presently disclosed methods have been described in conjunction with the specific language set forth herein above, it is evident that many alternatives, modifications, and variations will be apparent to those skilled in the art. Accordingly, it is intended to embrace all such alternatives, modifications, and variations that fall within the spirit and broad scope of the present disclosure. Changes may be made in the construction and the operation of the various components, elements, and assemblies described herein, as well as in the steps or the sequence of steps of the methods described herein, without departing from the spirit and scope of the present disclosure.

What is claimed is:

1. A method of processing black mass from lithium-ion batteries, the method comprising:
a) mixing black mass with a multiphase liquid blend of nonpolar hydrophobic solvent and water, to produce a multiphase admixture, wherein the black mass is derived from lithium-ion battery recycling and comprises lithium, graphite, and mixed metals, and wherein at least a portion of the lithium in the black mass is soluble in the water;
b) gravity phase separation of the multiphase admixture to produce a graphite layer comprising graphite and hydrophobic solvent, a mixed metal layer comprising metals and water, a hydrophobic solvent layer, and an aqueous layer comprising dissolved lithium;
c) recovering the dissolved lithium from the aqueous layer;
d) recovering the graphite from the graphite layer; and
e) recovering mixed metals from the mixed metal layer.

2. The method of claim 1, wherein the nonpolar hydrophobic solvent is selected from the group consisting of butanol, pentanol, hexanol, hexane, heptane, toluene, carbon tetrachloride, chloroform, methylene chloride, ethyl ether, vegetable oils, various esters, terpenes, and combinations thereof.

3. The method of claim 1, wherein the nonpolar hydrophobic solvent comprises hexane.

4. The method of claim 1, wherein the multiphase liquid blend of nonpolar hydrophobic solvent and water further comprises an acid.

5. The method of claim 4, wherein the acid comprises acids that are miscible in the nonpolar hydrophobic solvent.

6. The method of claim 4, wherein the acid comprises acids that are miscible in water.

7. The method of claim 4 wherein the acid comprises acetic acid.

8. The method of claim 4, wherein the nonpolar hydrophobic solvent comprises hexane and the acid comprises acetic acid.

9. The method of claim 1, wherein the volume ratio of nonpolar hydrophobic solvent to water is in a range of about 40:60 to about 60:40.

10. The method of claim 1, wherein the lithium is recovered from the aqueous layer by evaporation.

11. The method of claim 1, further comprising evaporating the hydrophobic solvent layer to precipitate and recover lithium.

12. Mixed metals produced by the method of claim 1.

13. Graphite produced by the method of claim 1.

14. A method of processing black mass from lithium-ion batteries, the method comprising:
a) mixing black mass with water to dissolve polar lithium from the black mass and produce water with dissolved polar lithium and water-leached black mass, wherein the black mass is derived from lithium-ion battery recycling and comprises lithium, graphite, and mixed metals;
b) evaporating the water with dissolved polar lithium to recover lithium;
c) mixing the water-leached black mass with a nonpolar hydrophobic solvent, and optionally an acid to produce a multiphase admixture;
d) gravity phase separation of the multiphase admixture to produce a graphite layer comprising graphite and hydrophobic solvent, a mixed metal layer comprising mixed metals and water, a hydrophobic solvent layer, and an aqueous layer;
e) recovering the graphite from the graphite layer; and
f) recovering mixed metals from the mixed metal layer.

15. Mixed metals produced by the method of claim 14.

16. Graphite produced by the method of claim 14.
